(19) United States
(12) Patent Application Publication
(10) Pub. No.: US 2025/0195951 A1
(43) Pub. Date: Jun. 19, 2025

(54) POSITION MANAGEMENT SYSTEM AND POSITION MANAGEMENT METHOD

(71) Applicant: SEIKO EPSON CORPORATION, Tokyo (JP)

(72) Inventor: Naoki GOBARA, SHIOJIRI-SHI (JP)

(73) Assignee: SEIKO EPSON CORPORATION, Tokyo (JP)

(21) Appl. No.: 18/983,285

(22) Filed: Dec. 16, 2024

(30) Foreign Application Priority Data
Dec. 18, 2023 (JP) 2023-212730

(51) Int. Cl. A63B 24/00; G01S 19/42

(52) U.S. Cl. CPC A63B 24/0021; G01S 19/42; A63B 2024/0025; A63B 2225/50

(57) ABSTRACT

A position management system including a first communication apparatus attached to a first competitor, and configured to acquire first location information representing a position of the first competitor from a GNSS system, a second communication apparatus attached to a second competitor, and configured to acquire second location information representing a position of the second competitor from the GNSS system, a server apparatus configured to receive the first location information from the first communication apparatus, and receive the second location information from the second communication apparatus, and a fixed communication apparatus configured to communicate with the first communication apparatus and the second communication apparatus. The first communication apparatus transmits the first location information to the server apparatus when the first communication apparatus communicates with the fixed communication apparatus, and the server apparatus causes the second communication apparatus to transmit the second location information.

The present application is based on, and claims priority from JP Application Serial Number 2023-212730, filed Dec. 18, 2023, the disclosure of which is hereby incorporated by reference herein in its entirety.

### BACKGROUND

### 1. Technical Field

The present disclosure relates to a position management system and a position management method.

### 2. Related Art

JP-A-2023-56634 discloses that when entry of a competitor into a predetermined region (transition area) is detected with a GPS reception apparatus attached to the competitor, it is determined that the competitor is at a check point where the event performed by the competitor changes.

The technique disclosed in JP-A-2023-56634 acquires the location information from the GPS reception apparatus at a regular time interval, and as such has the following problems. Specifically, when the timing when the competitor enters the predetermined region is different from the timing of acquiring the location information of other competitors, the location information of the other competitors cannot be acquired.

### SUMMARY

A position management system according to an aspect of the present disclosure includes a first communication apparatus attached to a first competitor who participates in a competition in which competitors moves along a course, the first communication apparatus being configured to acquire first location information representing a position of the first competitor from a GNSS system, a second communication apparatus attached to a second competitor different from the first competitor who participates in the competition, the second communication apparatus being configured to acquire second location information representing a position of the second competitor from the GNSS system, an information processing apparatus configured to receive the first location information from the first communication apparatus, and receive the second location information from the second communication apparatus, and a fixed communication apparatus disposed at a predetermined position in the course, and configured to communicate with the first communication apparatus and the second communication apparatus. The first communication apparatus transmits the first location information to the information processing apparatus when the first communication apparatus communicates with the fixed communication apparatus, and the information processing apparatus causes the second communication apparatus to transmit the second location information when the first communication apparatus and the fixed communication apparatus communicate with each other.

A position management method according to an aspect of the present disclosure is a method of a position management system, the position management system including a first communication apparatus attached to a first competitor who participates in a competition in which competitors moves along a course, the first communication apparatus being configured to acquire first location information representing a position of the first competitor from a GNSS system, a second communication apparatus attached to a second competitor different from the first competitor who participates in the competition, the second communication apparatus being configured to acquire second location information representing a position of the second competitor from the GNSS system, an information processing apparatus configured to receive the first location information from the first communication apparatus, and receive the second location information from the second communication apparatus, and a fixed communication apparatus disposed at a predetermined position in the course, and configured to communicate with the first communication apparatus and the second communication apparatus, the method including transmitting, by the first communication apparatus, the first location information to the information processing apparatus when the first communication apparatus communicates with the fixed communication apparatus, and causing, by the information processing apparatus, the second communication apparatus to transmit the second location information when the first communication apparatus and the fixed communication apparatus communicate with each other.

### BRIEF DESCRIPTION OF THE DRAWINGS

FIG. 1 is a diagram illustrating an example of a configuration of a position management system according to an embodiment.

FIG. 2 is a diagram illustrating an example of a configuration of a first communication apparatus.

FIG. 3 is a diagram illustrating an example of a configuration of a second communication apparatus.

FIG. 4 is a diagram illustrating an example of a configuration of a server apparatus.

FIG. 5 is a diagram illustrating an example of a configuration of a fixed communication apparatus.

FIG. 6 is a diagram illustrating an example of processes of a position calculation unit and a determination unit of a server apparatus.

FIG. 7 is a diagram illustrating an example of processes of the position calculation unit and the determination unit of the server apparatus.

FIG. 8 is a flowchart illustrating an example of a process of the position management system.

FIG. 9 is a flowchart illustrating an example of a process of the server apparatus.

### DESCRIPTION OF EMBODIMENTS

Δn embodiment is described below with reference to the accompanying drawings.

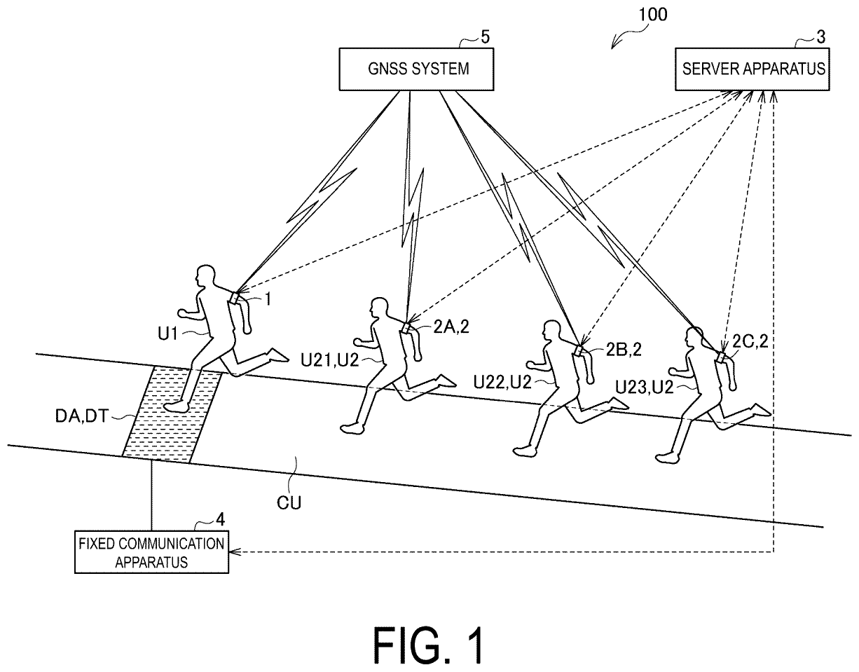

First, with reference to FIG. 1, a configuration of a position management system 100 according to the embodiment is described. FIG. 1 is a diagram illustrating an example of a configuration of the position management system 100 according to the embodiment. As illustrated in FIG. 1, the position management system 100 includes a first communication apparatus 1, a second communication apparatus 2, a server apparatus 3, and a fixed communication apparatus 4.

The first communication apparatus 1 is attached to a first competitor U1. The first communication apparatus 1 is attached to the upper arm of the first competitor U1, for example.

The first competitor U1 participates in a competition in which competitors move along a course CU. The competition is, for example, a marathon. The following describes a case where the competition is a marathon. The following describes a case where the first competitor U1 is a competitor who runs at the front in a marathon.

The first communication apparatus 1 acquires first location information PS1 from a GNSS (Global Navigation Satellite System) system 5. The first location information PS1 represents the position of the first competitor U1.

The first communication apparatus 1 acquires the first location information PS1 at an interval of a predetermined time from the GNSS system 5, for example. The predetermined time is 10 seconds, for example.

In addition, when acquiring the first location information PS1 from the GNSS system 5, the first communication apparatus 1 acquires first date/time information TM1 representing the date/time corresponding to the first location information PS1 from the GNSS system 5.

In addition, the first communication apparatus 1 transmits to the server apparatus 3 the first location information PS1 in association with the first date/time information TM1. The first communication apparatus 1 transmits the first location information PS1 and the first date/time information TM1 to the server apparatus 3 at an interval of a predetermined time. The predetermined time is 10 seconds, for example.

In addition, when communicating with the fixed communication apparatus 4, the first communication apparatus 1 transmits the first location information PS1 and the first date/time information TM1 to the server apparatus 3, for example.

Note that, when the first competitor U1 enters a detection region DA disposed in the course CU, the first communication apparatus 1 communicates with the fixed communication apparatus 4. A pressure sensor, which is disposed in the detection region DA, detects the entry of a competitor U into the detection region DA, for example.

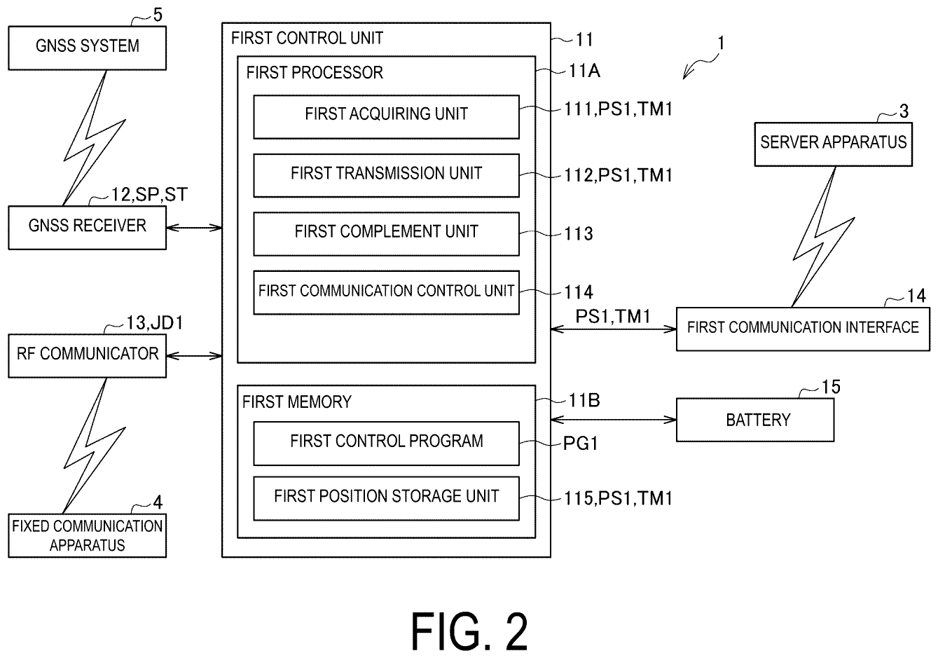

The configuration of the first communication apparatus 1 will be further described with reference to FIG. 2.

The second communication apparatus 2 is attached to a second competitor U2. The second communication apparatus 2 is attached to the upper arm of the second competitor U2.

The second competitor U2 participates in a marathon as with the first competitor U1.

The following describes a case where the second competitor U2 is a competitor who runs second or later in the marathon. The second competitor U2 includes a plurality of competitors. For example, the second competitor U2 includes a second competitor U21, a second competitor U22, and a second competitor U23, for example. The second competitor U21 is a competitor who runs second, for example. The second competitor U22 is a competitor who runs third, for example. The second competitor U23 is a competitor who runs fourth, for example.

In the following description, when the second competitor U21, the second competitor U22, and the second competitor U23 are not discriminated from each other, each of the second competitor U21, the second competitor U22, and the second competitor U23 may be referred to as the second competitor U2.

A second communication apparatus 2A is attached to the upper arm of the second competitor U21. A second communication apparatus 2B is attached to the upper arm of the second competitor U22. A second communication apparatus 2C is attached to the upper arm of the second competitor U23. Specifically, the second communication apparatus 2 includes the second communication apparatus 2A, the second communication apparatus 2B, and the second communication apparatus 2C.

The second communication apparatus 2A, the second communication apparatus 2B, and the second communication apparatus 2C have substantially the same configuration. In view of this, in the following description, when the second communication apparatus 2A, the second communication apparatus 2B, and the second communication apparatus 2C are not discriminated from each other, each of the second communication apparatus 2A, the second communication apparatus 2B, and the second communication apparatus 2C may be referred to as the second communication apparatus 2.

The second communication apparatus 2 acquires second location information PS2 from the GNSS system 5. The second location information PS2 represents the position of the second competitor U2.

The second communication apparatus 2 acquires the second location information PS2 from the GNSS system 5 at an interval of a predetermined time, for example. The predetermined time is 10 seconds, for example.

In addition, when acquiring the second location information PS2 from the GNSS system 5, the second communication apparatus 2 acquires from the GNSS system 5 second date/time information TM2 representing the date/time corresponding to the second location information PS2.

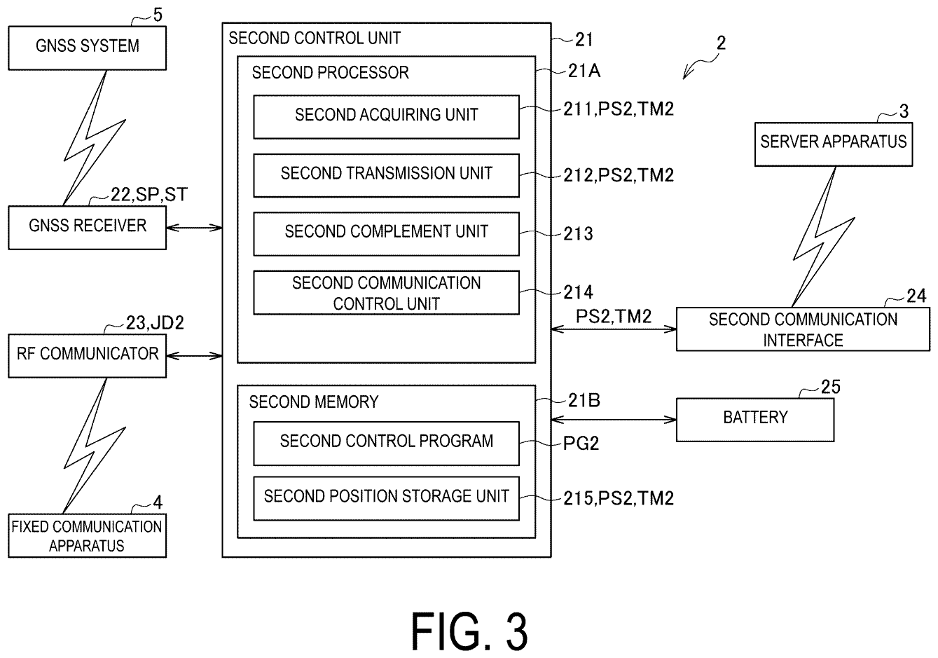

In addition, the second communication apparatus 2 transmits to the server apparatus 3 the second location information PS2 in association with the second date/time information TM2. The second communication apparatus 2 transmits the second location information PS2 and the second date/time information TM2 to the server apparatus 3 at an interval of a predetermined time. The predetermined time is 100 seconds, for example. The configuration of the second communication apparatus 2 will be further described with reference to FIG. 3.

When the first competitor U1 enters the detection region DA disposed in the course CU, the fixed communication apparatus 4 communicates with the first communication apparatus 1. When the first competitor U1 enters the detection region DA, the fixed communication apparatus 4 acquires from the first communication apparatus 1 first identification information JD1 that is identification information for identifying the first communication apparatus 1, for example. In addition, the fixed communication apparatus 4 transmits the acquired first identification information JD1, fixed date/time information TMF, and fixed location information PSF to the server apparatus 3.

The fixed date/time information TMF represents the date/time when the first competitor U1 entered the detection region DA disposed in the course CU. The fixed location information PSF represents the position of the detection region DA.

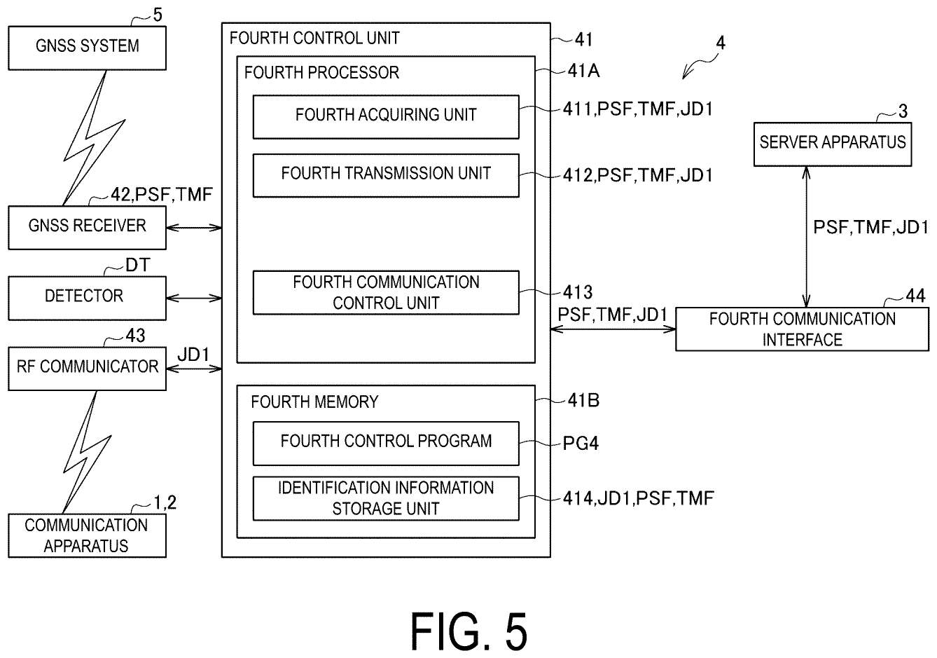

The configuration of the fixed communication apparatus 4 will be further described with reference to FIG. 5.

The fixed communication apparatus 4 is disposed at an interval of a predetermined distance from the start position of the marathon along the course CU, for example. The predetermined distance is 10 km, for example. The predetermined distance may also be 5 km, for example.

The server apparatus 3 receives the first location information PS1 from the first communication apparatus 1, and receives the second location information PS2 from the second communication apparatus 2.

In addition, when receiving the first location information PS1 from the first communication apparatus 1, the server apparatus 3 acquires the first date/time information TM1 in association with the first location information PS1 from the first communication apparatus 1. When receiving the second location information PS2 from the second communication apparatus 2, the server apparatus 3 acquires the second date/time information TM2 in association with the second location information PS2 from the second communication apparatus 2.

In addition, the server apparatus 3 receives the first identification information JD1 from the fixed communication apparatus 4.

The server apparatus 3 corresponds to an example of the “information processing apparatus”.

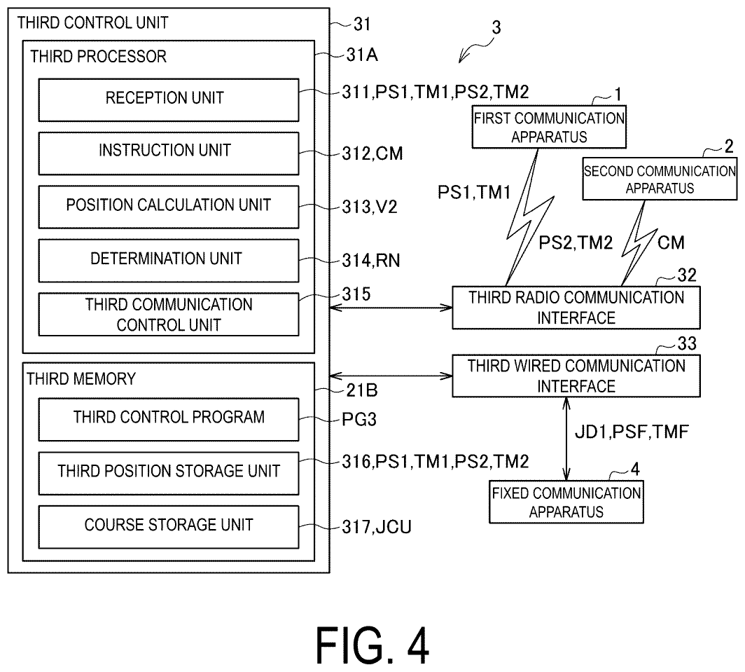

The configuration of the server apparatus 3 will be further described with reference to FIG. 4.

Next, with reference to FIG. 2, a configuration of the first communication apparatus 1 is described. FIG. 2 is a diagram illustrating an example of the configuration of the first communication apparatus 1. As illustrated in FIG. 2, the first communication apparatus 1 includes a first control unit 11, a GNSS receiver 12, an RF (Radio Frequency) communicator 13, a first communication interface 14, and a battery 15.

The first control unit 11 controls each unit of the first communication apparatus 1. The battery 15 supplies power to each unit of the first communication apparatus 1 under the instruction of the first control unit 11.

The GNSS receiver 12 receives a GNSS signal from the GNSS system 5 under the instruction of the first control unit 11. The GNSS receiver 12 includes an antenna. The GNSS receiver 12 outputs the GNSS signal received from the GNSS system 5 to the first control unit 11.

The GNSS signal includes a position signal SP and a date/time signal ST. The position signal SP corresponds to location information PS that represents the position of the GNSS receiver 12. The date/time signal ST represents the date/time corresponding to the position signal SP. Specifically, the date/time signal ST represents the date/time when the position signal SP is received by the GNSS receiver 12.

In addition, the GNSS receiver 12 turns on and off under the instruction of the first control unit 11. The GNSS receiver 12 is composed of an IC (Integrated Circuit), for example.

When the first competitor U1 enters the detection region DA, the RF communicator 13 communicates with the fixed communication apparatus 4. The RF communicator 13 stores the first identification information JD1, and transmits the first identification information JD1 to the fixed communication apparatus 4 when the first competitor U1 enters the detection region DA, for example. The RF communicator 13 is composed as a so-called “RF tag”.

The first communication interface 14 includes an antenna, a connector and an interface circuit, and is coupled to the first control unit 11. The first communication interface 14 is an interface for communicating with the server apparatus 3. The first communication interface 14 is an interface for communicating with the server apparatus 3 in accordance with LTE (registered trademark) (Long Term Evolution) standard.

The first control unit 11 includes a first processor 11A and a first memory 11B.

The first memory 11B is a storage apparatus that stores in a non-volatile manner the programs and data to be executed by the first processor 11A. The first memory 11B is composed of a magnetic storage apparatus, a semiconductor memory element such as a flash ROM (read only memory), or other nonvolatile storage apparatuses. In addition, the first memory 11B may include a RAM (random access memory) making up the work area of the first processor 11A. The first memory 11B stores data to be processed by the first control unit 11, a first control program PG1 to be executed by the first processor 11A and the like.

The first processor 11A may be composed of a single processor, or may be configured such that a plurality of processors functions as the first processor 11A. The first processor 11A controls each unit of the first communication apparatus 1 by executing the first control program PG1.

The first processor 11A may be composed of a part or all of the first memory 11B, and a SoC (System on Chip) integrated with other circuits. In addition, the first processor 11A may be composed of a combination of a CPU (Central Processing Unit) for executing programs, and a DSP (Digital Signal Processor) for executing predetermined arithmetic processing. All functions of the first processor 11A may be mounted on hardware, or may be configured using a programmable device.

The following describes a case where the first processor 11A executes the first control program PG1 to control each unit of the first communication apparatus 1.

Next, with reference to FIG. 2, a functional configuration of the first control unit 11 is described. The first control unit 11 includes a first acquiring unit 111, a first transmission unit 112, a first complement unit 113, a first communication control unit 114, and a first position storage unit 115.

More specifically, when the first processor 11A executes the first control program PG1, it functions as the first acquiring unit 111, the first transmission unit 112, the first complement unit 113, and the first communication control unit 114. In addition, when the first processor 11A executes the first control program PG1, the first memory 11B functions as the first position storage unit 115.

The first position storage unit 115 stores the first location information PS1 and the first date/time information TM1 in association with each other. The first location information PS1 corresponds to the position signal SP that is acquired by the GNSS receiver 12 from the first acquiring unit 111. The first date/time information TM1 corresponds to the date/time signal ST that is acquired by the first acquiring unit 111 from the GNSS receiver 12. In addition, the first location information PS1 and the first date/time information TM1 are stored by the first acquiring unit 111 in the first position storage unit 115.

The first acquiring unit 111 acquires the first location information PS1 and the first date/time information TM1 from the GNSS system 5 through the GNSS receiver 12. The first acquiring unit 111 acquires the first location information PS1 and the first date/time information TM1 from the GNSS system 5 at an interval of a predetermined time, for example. The predetermined time is 10 seconds, for example. The following describes a case where the predetermined time is 10 seconds.

In addition, when the RF communicator 13 communicates with the fixed communication apparatus 4, the first acquiring unit 111 acquires the first location information PS1 and the first date/time information TM1 from the GNSS system 5 through the GNSS receiver 12.

In addition, the first acquiring unit 111 stores in the first position storage unit 115 the first date/time information TM1 and the first location information PS1 acquired from the GNSS system 5 in association with each other.

The first transmission unit 112 transmits to the server apparatus 3 the first location information PS1 in association with the first date/time information TM1. The first transmission unit 112 transmits the first location information PS1 and the first date/time information TM1 stored in the first position storage unit 115 to the server apparatus 3 at an interval of a predetermined time, for example. The predetermined time is 10 seconds, for example. The following describes a case where the predetermined time is 10 seconds. In other words, the first transmission unit 112 transmits, to the server apparatus 3, 10 pieces of the first location information PS1 stored in the first position storage unit 115, and 10 pieces of the first date/time information TM1 stored in the first position storage unit 115 in association with the respective 10 pieces of the first location information PS1 every 100 seconds, for example.

Note that, the first transmission unit 112 may transmit the first location information PS1 and first elapsed time information PD1 to the server apparatus 3 when the RF communicator 13 communicates with the fixed communication apparatus 4. The first elapsed time information PD1 represents the time from the start time of the marathon to the first date/time represented by the first date/time information TM1.

In addition, when the RF communicator 13 communicates with the fixed communication apparatus 4, the first transmission unit 112 transmits to the server apparatus 3 the first date/time information TM1 and the first acquiring unit 111 acquired by the first location information PS1 in association with each other.

The first complement unit 113 calculates a first velocity V1 of the movement of the first competitor U1 on the basis of the first location information PS1, and complements the first location information PS1 on the basis of the first velocity V1.

For example, in the case where the position represented by the first location information PS1 moves from a first position PA to a second position PB, and the difference between the date/time of the first position PA and the date/time of the second position PB is ten seconds, the first complement unit 113 calculates the first velocity V1 by the following Equation (1).

V1=ΔL/10 (1)

The distance ΔL represents the distance (m) between the first position PA and the second position PB. The unit of the first velocity V1 is (m/sec).

The first complement unit 113 calculates the position of the first competitor U1 one second after the first position PA as a distance ΔL1 from the first position PA on the line connecting the first position PA and the second position PB by the following Equation (2).

ΔL1=1×V1 (2)

Likewise, the first complement unit 113 calculates the position of the first competitor U1 after N seconds from the first position PA as a distance ΔLN from the first position PA on the line connecting the first position PA and the second position PB by the following Equation (3). Note that, the integer N is an integer from “2” to “9”. ΔLN=N×V1 (3)

In this manner, the first complement unit 113 complements the first location information PS1 between the first position PA and the second position PB.

The first communication control unit 114 controls the communication of the GNSS receiver 12 with the GNSS system 5. In addition, the first communication control unit 114 controls the communication of the RF communicator 13 with the fixed communication apparatus 4. In addition, the first communication control unit 114 controls the communication of the first communication interface 14 with the server apparatus 3.

Next, with reference to FIG. 3, a configuration of the second communication apparatus 2 is described. FIG. 3 is a diagram illustrating an example of the configuration of the second communication apparatus 2. As illustrated in FIG. 3, the second communication apparatus 2 includes a second control unit 21, a GNSS receiver 22, an RF communicator 23, a second communication interface 24, and a battery 25.

The second control unit 21 controls each unit of the second communication apparatus 2. The battery 25 supplies power to each unit of the second communication apparatus 2 under the instruction of the second control unit 21.

The second control unit 21 corresponds to the first control unit 11 of the first communication apparatus 1 illustrated in FIG. 2. The GNSS receiver 22 corresponds to the RF communicator 13 of the first communication apparatus 1 illustrated in FIG. 2. The second communication interface 24 corresponds to the first communication interface 14 of the first communication apparatus 1 illustrated in FIG. 2. The battery 25 corresponds to the battery 15 of the first communication apparatus 1 illustrated in FIG. 2.

The following mainly describes a configuration of each unit of the second communication apparatus 2 different from each unit of the first communication apparatus 1, and the description for a configuration of each unit of the second communication apparatus 2 common to each unit of the first communication apparatus 1 is omitted.

When the second competitor U2 enters the detection region DA, the RF communicator 23 communicates with the fixed communication apparatus 4. The RF communicator 23 stores second identification information JD2, and transmits the second identification information JD2 to the fixed communication apparatus 4 when the second competitor U2 enters the detection region DA, for example.

The second control unit 21 includes a second processor 21A and a second memory 21B. The second processor 21A corresponds to the first processor 11A of the first control unit 11 illustrated in FIG. 2. The second memory 21B corresponds to the first memory 11B of the first control unit 11 illustrated in FIG. 2.

Next, with reference to FIG. 3, a functional configuration of the second control unit 21 is described. The second control unit 21 includes a second acquiring unit 211, a second transmission unit 212, a second complement unit 213, a second communication control unit 214, and a second position storage unit 215.

More specifically, when the second processor 21A executes a second control program PG2, it functions as the second acquiring unit 211, the second transmission unit 212, the second complement unit 213, and the second communication control unit 214. In addition, when the second processor 21A executes the second control program PG2, the second memory 21B functions as the second position storage unit 215.

The second acquiring unit 211 corresponds to the first acquiring unit 111 of the first control unit 11 illustrated in FIG. 2. The second transmission unit 212 corresponds to the first transmission unit 112 of the first control unit 11 illustrated in FIG. 2. The second complement unit 213 corresponds to the first complement unit 113 of the first control unit 11 illustrated in FIG. 2. The second communication control unit 214 corresponds to the first communication control unit 114 of the first control unit 11 illustrated in FIG. 2. The second position storage unit 215 corresponds to the first position storage unit 115 of the first control unit 11 illustrated in FIG. 2.

Functions of each unit of the second control unit 21 that differ from those of each unit of the first control unit 11 are mainly described, and the description for functions common to those of each unit of the first control unit 11 is omitted.

The second position storage unit 215 stores the second location information PS2 and the second date/time information TM2 in association with each other. The second location information PS2 corresponds to the position signal SP that is acquired by the second acquiring unit 211 from the GNSS receiver 22. The second date/time information TM2 corresponds to the date/time signal ST that is acquired by the second acquiring unit 211 from the GNSS receiver 22. In addition, the second location information PS2 and the second date/time information TM2 are stored in the first position storage unit 115 by the second acquiring unit 211.

The second acquiring unit 211 acquires the second location information PS2 and the second date/time information TM2 from the GNSS system 5 through the GNSS receiver 22. The second acquiring unit 211 acquires the second location information PS2 and the second date/time information TM2 from the GNSS system 5 at an interval of a predetermined time, for example. The predetermined time is 10 seconds, for example. The following describes a case where the predetermined time is 10 seconds.

In addition, the second acquiring unit 211 stores the second location information PS2 and the second date/time information TM2 acquired from the GNSS system 5 in association with each other in the first position storage unit 115.

Note that, the second acquiring unit 211 does not execute the process of acquiring the second location information PS2 and the second date/time information TM2 from the GNSS system 5 through the GNSS receiver 12 when the RF communicator 23 communicates with the fixed communication apparatus 4. Especially in this point, the second acquiring unit 211 differs from the first acquiring unit 111.

The second transmission unit 212 transmits to the server apparatus 3 the second location information PS2 in association with the second date/time information TM2. The second transmission unit 212 transmits the second location information PS2 and the second date/time information TM2 stored in the second position storage unit 215 to the server apparatus 3 at an interval of a predetermined time, for example. The predetermined time is 10 seconds, for example. The following describes a case where the predetermined time is 100 seconds.

In other words, the second transmission unit 212 transmits to the server apparatus 3 10 pieces of the second location information PS2 stored in the first position storage unit 115 and 10 pieces of the second date/time information TM2 stored in the second position storage unit 215 in association with the respective 10 pieces of the second location information PS2 every 100 seconds, for example.

In addition, when the RF communicator 13 of the first communication apparatus communicates with the fixed communication apparatus 4, the second transmission unit 212 transmits to the server apparatus 3 the second location information PS2 and the second date/time information TM2 acquired by the second acquiring unit 211 in association with each other in accordance with instruction information CM from the server apparatus 3.

In particular, the second transmission unit 212 differs from the first transmission unit 112 in that the second transmission unit 212 transmits the second location information PS2 and the second date/time information TM2 to the server apparatus 3 under the instruction of the server apparatus 3.

The instruction information CM will be further described with reference to FIG. 4.

The second complement unit 213 calculates a second velocity V2 of the movement of the second competitor U2 on the basis of the second location information PS2, and complements the second location information PS2 on the basis of the second velocity V2.

For example, in the case where the position represented by the second location information PS2 moves from a first position PC to a second position PD, and the difference between the date/time of the first position PC and the date/time of the second position PD is ten seconds, the second complement unit 213 calculates the second velocity V2 by the following Equation (4).

V2=ΔL/10 (4)

The distance ΔL is the distance (m) between the first position PC and the second position PD. The unit of the second velocity V2 is (m/sec).

The second complement unit 213 calculates by the following Equation (5) the position of the second competitor U2 one second after the first position PC as the distance ΔL1 from the first position PC on the line connecting the first position PC and the second position PD.

ΔL1=1×V2 (5)

Likewise, the second complement unit 213 calculates by the following Equation (6) the position of the second competitor U2 after N seconds from the first position PC as the distance ΔLN from the first position PC on the line connecting the first position PC and the second position PD. Note that, the integer N is an integer from “2” to “9”. ΔLN=N×ΔL (6) In this manner, the second complement unit 213 complements the second location information PS2 between the first position PC and the second position PD.

The second communication control unit 214 controls the communication of the GNSS receiver 22 with the GNSS system 5. In addition, the second communication control unit 214 controls the communication of the RF communicator 13 with the fixed communication apparatus 4. In addition, the second communication control unit 214 controls the communication of the second communication interface 24 with the server apparatus 3.

Next, with reference to FIG. 4, a configuration of the server apparatus 3 is described. FIG. 4 is a diagram illustrating an example of the configuration of the server apparatus 3.

As illustrated in FIG. 4, the server apparatus 3 includes a third control unit 31, a third radio communication interface 32, and a third wired communication interface 33.

The third control unit 31 controls each unit of the server apparatus 3. Note that power is supplied to the server apparatus 3 from a commercial power source unlike the first communication apparatus 1 and the second communication apparatus 2.

The third radio communication interface 32 includes an antenna, a connector and an interface circuit, and is coupled to the third control unit 31. The third radio communication interface 32 is an interface for communicating with the first communication apparatus 1 and the second communication apparatus 2. The third radio communication interface 32 is an interface for communicating with the first communication apparatus 1 and the second communication apparatus 2 in accordance with LTE (registered trademark) standard, for example.

The third wired communication interface 33 includes a connector and an interface circuit, and is coupled to the third control unit 31. The third wired communication interface 33 is an interface for communicating with the fixed communication apparatus 4. The third wired communication interface 33 communicates with the fixed communication apparatus 4 in accordance with Ethernet (registered trademark) standard, for example.

Note that, the server apparatus 3 and the fixed communication apparatus 4 are communicatively coupled in accordance with Ethernet (registered trademark) standard through at least one of the Internet, WAN (Wide Area Network), and LAN (Local area network), for example.

The third control unit 31 includes a third processor 31A and a third memory 31B.

The third memory 31B is a storage apparatus that stores in a non-volatile manner the programs and data to be executed by the third processor 31A. The third memory 31B is composed of a magnetic storage apparatus, a semiconductor memory element such as a flash ROM, or other nonvolatile storage apparatuses. In addition, the third memory 31B may include a RAM making up the work area of the third processor 31A. The third memory 31B stores data to be processed by the third control unit 31, a third control program PG3 to be executed by the third processor 31A and the like.

The third processor 31A may be composed of a single processor, or may be configured such that a plurality of processors functions as the third processor 31A. The third processor 31A executes the third control program PG3 to control each unit of the server apparatus 3.

The third processor 31A may be composed of a part or all of the third memory 31B, and a SoC integrated with other circuits. In addition, the third processor 31A may be composed of a combination of a CPU for executing programs and a DSP for executing predetermined arithmetic processing. All functions of the third processor 31A may be mounted on hardware, or may be configured using a programmable device.

The following describes a case where the third processor 31A executes the third control program PG3 to control each unit of the server apparatus 3.

Next, with reference to FIG. 4, a functional configuration of the third control unit 31 is described. The third control unit 31 includes a reception unit 311, an instruction unit 312, a determination unit 314, a position calculation unit 313, a third communication control unit 315, a third position storage unit 316, and a course storage unit 317.

More specifically, when the third processor 31A executes the third control program PG3, it functions as the reception unit 311, the instruction unit 312, the determination unit 314, the position calculation unit 313, and the third communication control unit 315. In addition, when the third processor 31A executes the third control program PG3, the third memory 31B functions as the third position storage unit 316, and the course storage unit 317.

The third position storage unit 316 stores the first location information PS1 and the first date/time information TM1 received from the first communication apparatus 1 in association with each other. In addition, the third position storage unit 316 stores the second location information PS2 and the second date/time information TM2 received from the second communication apparatus 2 in association with each other. In addition, the third position storage unit 316 stores the first identification information JD1, the fixed location information PSF, and the fixed date/time information TMF received from the fixed communication apparatus 4 in association with each other.

The first location information PS1 and the first date/time information TM1 are received by the reception unit 311 from the first communication apparatus 1, and stored by the reception unit 311 in the third position storage unit 316. In addition, the second location information PS2 and the second date/time information TM2 are received by the reception unit 311 from the second communication apparatus 2, and stored by the reception unit 311 in the third position storage unit 316. In addition, the first identification information JD1 and the first date/time information TM1 are received by the reception unit 311 from the fixed communication apparatus 4, and stored by the reception unit 311 in the third position storage unit 316.

The course storage unit 317 stores in advance course information JC representing the course CU. In the case where the competition is a marathon, the course CU corresponds to the road or the like. The road making up the course CU vary in high and low positions in addition to the position on the horizontal plane corresponding to the so-called latitude and longitude. Therefore, the course storage unit 317 stores three-dimensional information as the course information JC.

The reception unit 311 receives the first location information PS1 and the first date/time information TM1 from the first communication apparatus 1. In addition, the reception unit 311 receives the second location information PS2 and the second date/time information TM2 from the second communication apparatus 2. In addition, the reception unit 311 receives the first identification information JD1, the fixed date/time information TMF, and the fixed location information PSF from the fixed communication apparatus 4. The fixed date/time information TMF represents the date/time when the first competitor U1 entered the detection region DA disposed in the course CU. The fixed location information PSF represents the position of the detection region DA.

The reception unit 311 stores in the third position storage unit 316 the first location information PS1 and the first date/time information TM1 received from the first communication apparatus 1. In addition, the reception unit 311 stores in the third position storage unit 316 the second location information PS2 and the second date/time information TM2 received from the second communication apparatus 2. In addition, the reception unit 311 stores in the third position storage unit 316 the first identification information JD1 and the first date/time information TM1 received from the fixed communication apparatus 4.

When the first communication apparatus 1 communicates with the fixed communication apparatus 4, the instruction unit 312 transmits, to the second communication apparatus 2, the instruction information CM that instructs to transmit the second location information PS2 in association with the second date/time information TM2 to the server apparatus 3. When receiving the instruction information CM, the second communication apparatus 2 transmits to the server apparatus 3 the second location information PS2 in association with the second date/time information TM2.

Note that, the second location information PS2 transmitted by the second communication apparatus 2 when receiving the instruction information CM is the second location information PS2 corresponding to the second location information PS2 closest to the first date/time information TM1 in the second location information PS2 stored in the second position storage unit 215. In other words, the second location information PS2 transmitted by the second communication apparatus 2 when receiving the instruction information CM is the first date/time information TM1, and the second location information PS2 acquired by the second communication apparatus 2 in the period up to 10 seconds before the first date/time information TM1. The reason for this is that the second communication apparatus 2 acquires the second location information PS2 from the GNSS system 5 every 10 seconds.

The embodiment describes a case where the instruction unit 312 transmits the instruction information CM to the second communication apparatus 2 when the first communication apparatus 1 attached to the first competitor U1 who is a competitor who runs at the front communicates with the fixed communication apparatus 4, but the embodiment is not limited to this.

The following describes a modification example of the instruction unit 312.

### First Modification Example

For example, in the case where the rank of the first competitor U1 is higher than the rank of the second competitor U2, and the first communication apparatus 1 communicates with the fixed communication apparatus 4, the instruction unit 312 may transmit the instruction information CM that instructs the second communication apparatus 2 to transmit the second location information PS2 to the server apparatus 3.

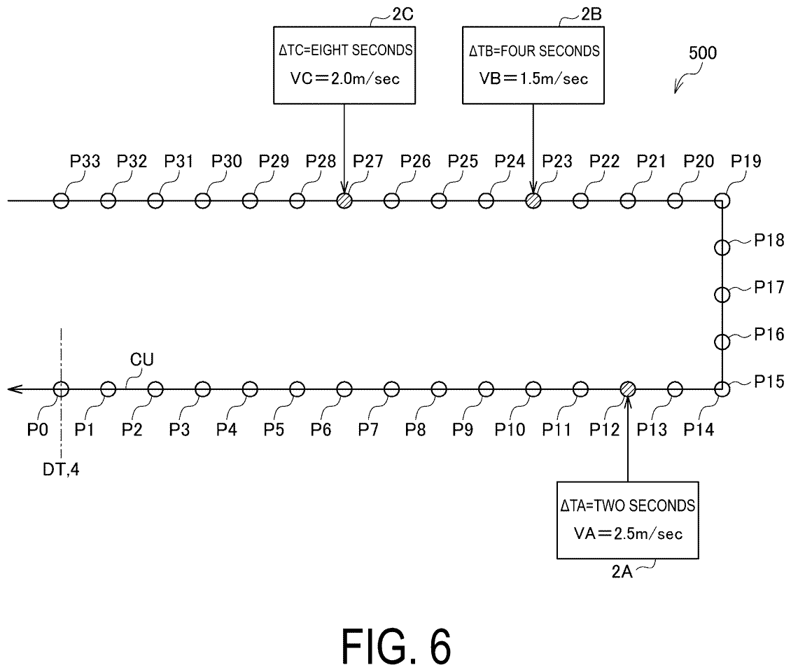

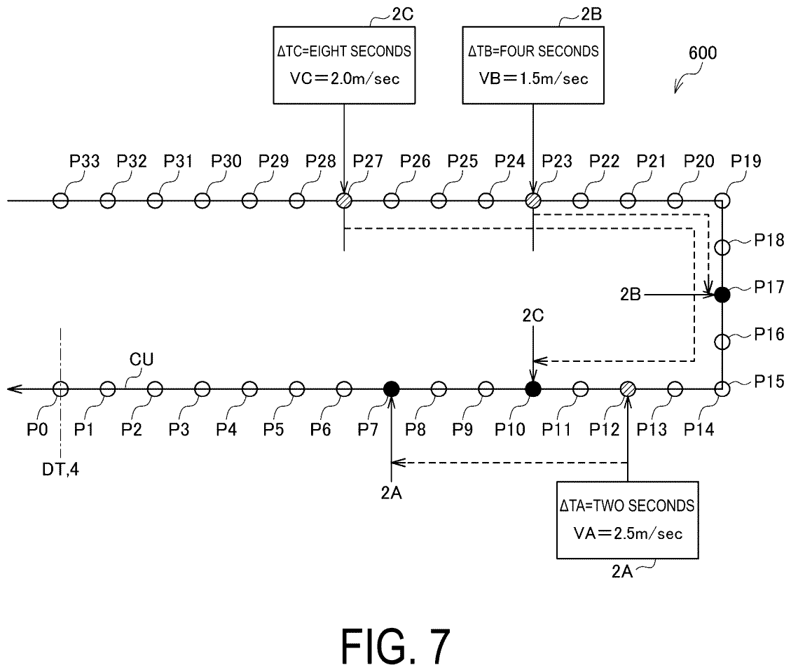

In this case, before the first communication apparatus 1 communicates with the fixed communication apparatus 4, it is necessary to determine the rank of the first competitor U1 on the basis of the number of communication apparatuses that have communicated with the fixed communication apparatus 4. In addition, it is preferable to transmit the instruction information CM that instructs the second communication apparatus 2 to transmit the second location information PS2 and the second date/time information TM2 to the server apparatus 3. In this case, the ranks of the second competitor U21, the second competitor U22, and the second competitor U23 can be determined as with the method described with reference to FIGS. 6 and 7.

### Second Modification Example

In addition, for example, in the case where the rank of the first competitor U1 is equal to or higher than the finishing rank in the marathon, and the rank of the first competitor U1 is higher than the rank of the second competitor U2, and, the first communication apparatus 1 communicates with the fixed communication apparatus 4, the instruction unit 312 may transmit the instruction information CM. The instruction information CM is information that instructs the second communication apparatus 2 to transmit the second location information PS2 to the server apparatus 3.

In this case, this modification differs (from the first modification) in that the rank of the first competitor U1 is equal to or higher than the finishing rank in the marathon. In this case, the rank of the first competitor U1 is equal to or higher than the finishing rank in the marathon, and therefore in comparison (with the first modification), it is possible to determine the rank of the second competitor U2 with higher interest of the user, such as the ranks of the second competitor U21, the second competitor U22, and the second competitor U23.

### Third Modification Example

In the case where the first communication apparatus 1 communicates with the fixed communication apparatus 4, and the second communication apparatus 2 is not communicated with the fixed communication apparatus 4, and, a distance L2 is equal to or smaller than a first threshold value TH1, the instruction unit 312 may transmit the instruction information CM to the second communication apparatus 2. The distance L2 is the distance of the first communication apparatus 1 and the second communication apparatus 2 along the course CU before the first communication apparatus 1 communicates with the fixed communication apparatus 4. In addition, the instruction information CM is information that instructs transmission of the second location information PS2 to the server apparatus 3.

In this case, in comparison (with the first modification), in the case where the distance L2 of the first communication apparatus 1 and the second communication apparatus 2 along the course CU is equal to or smaller than the first threshold value TH1 before the first communication apparatus 1 communicates with the fixed communication apparatus 4, the instruction unit 312 transmits the instruction information CM to the second communication apparatus 2. Thus, by properly setting the first threshold value TH1, the second communication apparatus 2 for which the rank is to be determined can be properly limited. For example, the first threshold value TH1 is 100 m. In this case, in the case where the distance L2 of the first communication apparatus 1 and the second communication apparatus 2 along the course CU is equal to or smaller than 100 m, the determination unit 314 determines the rank of the second competitor U2 on which the second communication apparatus 2 is attached.

### Fourth Modification Example

In the case where the first communication apparatus 1 communicates with the fixed communication apparatus 4, and the second communication apparatus 2 is not communicated with the fixed communication apparatus 4, and, the difference between the rank of the first competitor U1 and the rank of the second competitor U2 is equal to or smaller than a second threshold value TH2 before the first communication apparatus 1 communicates with the fixed communication apparatus 4, the second communication apparatus 2 transmits the second location information PS2.

In this case, in comparison (with the first modification), in the case where the difference between the rank of the first competitor U1 and the rank of the second competitor U2 is equal to or smaller than the second threshold value TH2 before the first communication apparatus 1 communicates with the fixed communication apparatus 4, the instruction unit 312 transmits the instruction information CM to the second communication apparatus 2. Thus, by properly setting the second threshold value TH2, the second communication apparatus 2 for which the rank is to be determined can be properly limited. For example, the second threshold value TH2 is “6”. In this case, the determination unit 314 determines the ranks of six second competitors U2.

The position calculation unit 313 calculates the second velocity V2 that is the velocity of the movement of the second competitor U2 on the basis of the second location information PS2. Then, the position calculation unit 313 calculates the position of the second communication apparatus 2 at the first date/time represented by the first date/time information TM1 on the basis of the second location information PS2, the second velocity V2, and the course information JC representing the course CU.

The determination unit 314 determines the rank of the first competitor U1 and the rank of the second competitor U2 in the marathon on the basis of the course information JC, the first location information PS1, the first date/time information TM1, the second location information PS2 and the second date/time information TM2.

The determination unit 314 determines the rank of the second competitor U2 in the marathon on the basis of the position of the second communication apparatus 2 calculated by the position calculation unit 313 at the first date/time represented by the first date/time information TM1, for example.

The processes of the position calculation unit 313 and the determination unit 314 will be further described with reference to FIGS. 6 and 7.

In the embodiment, the first competitor U1 is a competitor who runs at the front, and therefore the rank of the first competitor U1 is ranked first. In this case, the determination unit 314 determines the rank of the second competitor U2 in the marathon on the basis of the course information JC, the first location information PS1, the first date/time information TM1, the second location information PS2, and the second date/time information.

In addition, in the embodiment, the second competitor U2 includes the second competitor U21, the second competitor U22, and the second competitor U23. Specifically, the determination unit 314 determines the ranks of the second competitor U21, the second competitor U22, and the second competitor U23.

Note that, the embodiment assumes that the first location information PS1 coincides with the fixed location information PSF, and that the first date/time information TM1 coincides with the fixed date/time information TMF, but the embodiment is not limited to this.

For example, in the case where the first location information PS1 does not coincide with the fixed location information PSF, the determination unit 314 preferably uses the fixed location information PSF instead of the first location information PS1. In this case, the determination unit 314 determines the rank RN of the first competitor U1 and the rank RN of the second competitor U2 in the marathon on the basis of the course information JC, the fixed location information PSF, the first date/time information TM1, the second location information PS2, and the second date/time information.

In addition, for example, in the case where the first date/time information TM1 does not coincide with the fixed date/time information TMF, the determination unit 314 preferably uses the fixed date/time information TMF instead of the first date/time information TM1. In this case, the determination unit 314 determines the rank RN of the first competitor U1 and the rank RN of the second competitor U2 in the marathon on the basis of the course information JC, the first location information PS1, the fixed date/time information TMF, the second location information PS2, and the second date/time information.

In addition, for example, in the case where the first location information PS1 does not coincide with the fixed location information PSF, and the first date/time information TM1 does not coincide with the fixed date/time information TMF, the determination unit 314 preferably uses the fixed location information PSF instead of the first location information PS1, and preferably uses the fixed date/time information TMF instead of the first date/time information TM1. In this case, the determination unit 314 determines the rank RN of the first competitor U1 and the rank RN of the second competitor U2 in the marathon on the basis of the course information JC, the fixed location information PSF, the fixed date/time information TMF, second location information PS2, and the second date/time information.

The third communication control unit 315 controls the communication of the third radio communication interface 32 with the first communication apparatus 1 and the second communication apparatus 2. In addition, the third communication control unit 315 controls the communication of the third wired communication interface 33 with the fixed communication apparatus 4.

Next, with reference to FIG. 5, a configuration of the fixed communication apparatus 4 is described. FIG. 5 is a diagram illustrating an example of the configuration of the fixed communication apparatus 4.

As illustrated in FIG. 5, the fixed communication apparatus 4 includes a fourth control unit 41, a GNSS receiver 42, a detector DT, an RF communicator 43, and a fourth communication interface 44.

The fourth control unit 41 controls each unit of the fixed communication apparatus 4.

The GNSS receiver 42 receives the GNSS signal from the GNSS system 5 under the instruction of the fourth control unit 41. The GNSS receiver 42 includes an antenna. The GNSS receiver 42 outputs the GNSS signal received from the GNSS system 5 to the fourth control unit 41.

The GNSS signal includes a position signal SP and a date/time signal ST. The position signal SP corresponds to the fixed location information PSF that represents the position of the GNSS receiver 42. The date/time signal ST represents the date/time corresponding to the position of the GNSS receiver 42.

The GNSS receiver 42 receives the position signal SP from the GNSS system 5 before the start of the marathon, and acquires the fixed location information PSF, for example.

In addition, the GNSS receiver 42 turns on and off under the instruction of the fourth control unit 41. The GNSS receiver 42 is composed of an IC, for example.

The RF communicator 43 communicates with the first communication apparatus 1 when the first competitor U1 enters the detection region DA. The RF communicator 43 receives the first identification information JD1 from the first communication apparatus 1 when the first competitor U1 enters the detection region DA, for example.

The detector DT is disposed in the detection region DA illustrated in FIG. 1, and detects the entry of the competitor U into the detection region DA. The detector DT detects the entry of the first competitor U1 into the detection region DA, for example. The detector DT is composed of a pressure sensor, for example. The detector DT outputs a detection signal that represents the entry of the competitor U into the detection region DA to the fourth control unit 41. The detector DT outputs a detection signal that represents the entry of the first competitor U1 into the detection region DA to the fourth control unit 41, for example.

The fourth communication interface 44 includes a connector and an interface circuit, and is coupled to the fourth control unit 41. The fourth communication interface 44 is an interface for communicating with the server apparatus 3. The fourth communication interface 44 communicates with the server apparatus 3 in accordance with Ethernet (registered trademark) standard, for example.

The fourth control unit 41 includes a fourth processor 41A and a fourth memory 41B.

The fourth memory 41B is a storage apparatus that stores in a non-volatile manner the programs and data to be executed by the fourth processor 41A. The fourth memory 41B is composed of a magnetic storage apparatus, a semiconductor memory element such as a flash ROM, or other nonvolatile storage apparatuses. In addition, the fourth memory 41B may include a RAM making up the work area of the fourth processor 41A. The fourth memory 41B stores data to be processed by the fourth control unit 41 and a fourth control program PG4 to be executed by the fourth processor 41A and the like.

The fourth processor 41A may be composed of a single processor, or may be configured such that a plurality of processors functions as the fourth processor 41A. The fourth processor 41A executes the fourth control program PG4 to control each unit of the fixed communication apparatus 4.

The fourth processor 41A may be composed of a part or all of the fourth memory 41B, and a SoC integrated with other circuits. In addition, the fourth processor 41A may be composed of a combination of a CPU for executing programs and a DSP for executing predetermined arithmetic processing. All functions of the fourth processor 41A may be mounted on hardware, or may be configured using a programmable device.

The following describes a case where the fourth processor 41A executes the fourth control program PG4 to control each unit of the fixed communication apparatus 4.

Next, with reference to FIG. 4, a functional configuration of the fourth control unit 41 is described. The fourth control unit 41 includes a fourth acquiring unit 411, a fourth transmission unit 412, a fourth communication control unit 413, and an identification information storage unit 414.

More specifically, when the fourth processor 41A executes the fourth control program PG4, it functions as the fourth acquiring unit 411, the fourth transmission unit 412, and the fourth communication control unit 413. In addition, when the fourth processor 41A executes the fourth control program PG4, the fourth memory 41B functions as the identification information storage unit 414.

The identification information storage unit 414 stores the first identification information JD1 received from the first communication apparatus 1. In addition, the identification information storage unit 414 stores the fixed location information PSF before the start of the marathon, for example. The fixed location information PSF represents the position of the GNSS receiver 42. In addition, the identification information storage unit 414 may store the fixed date/time information TMF in association with the first identification information JD1. The fixed date/time information TMF is acquired by the GNSS receiver 42 from the GNSS system 5 when the first competitor U1 enters the detection region DA.

The first identification information JD1 and the fixed date/time information TMF are acquired by the fourth acquiring unit 411, and stored by the fourth acquiring unit 411 in the identification information storage unit 414.

The fourth acquiring unit 411 acquires the first identification information JD1 from the first communication apparatus 1 when the first communication apparatus 1 communicates with the RF communicator 43. In addition, when the first communication apparatus 1 communicates with the RF communicator 43, the fourth acquiring unit 411 acquires the fixed date/time information TMF from the GNSS system 5 through the GNSS receiver 42.

The fourth acquiring unit 411 stores the fixed date/time information TMF in association with the first identification information JD1 in the identification information storage unit 414.

The fourth transmission unit 412 transmits to the server apparatus 3 the first identification information JD1, the fixed location information PSF, and the fixed date/time information TMF acquired by the fourth acquiring unit 411.

The fourth communication control unit 413 controls the communication of the fourth communication interface 44 with the server apparatus 3.

Next, with reference to FIGS. 6 and 7, the processes of the position calculation unit 313 and the determination unit 314 of the server apparatus 3 are described. FIGS. 6 and 7 are each a diagram illustrating an example of the processes of the position calculation unit 313 and the determination unit 314 of the server apparatus 3.

A data display diagram 500 illustrated in FIG. 6 indicates data used by the position calculation unit 313 of the server apparatus 3 to calculate the positions of the second competitor U21, the second competitor U22 and the second competitor U23 at the first date/time represented by the first date/time information TM1.

The data display diagram 500 includes the course CU, a position mark PO to a position mark P33. As illustrated in FIG. 6, the course CU is formed in a U shape in plan view. The position mark PO indicates a position on the course CU where the fixed communication apparatus 4 including the detector DT is disposed.

The position mark PN (N=1 to 33), which is located on the side opposite to the running direction of the competitor U with respect to the position mark PO, indicates a position of a distance of N (m) from the position mark PO. For example, position mark P10, which is located on the side opposite to the running direction of the competitor U with respect to the position mark PO, indicates a position of a distance of 10 m from the position mark PO.

In addition, the data display diagram 500 indicates the second location information PS2 that is received from the second communication apparatus 2 at the instruction unit 312 at a time point when the first communication apparatus 1 communicates with the fixed communication apparatus 4. Specifically, it indicates the second location information PS2A that is received from the second communication apparatus 2A, the second location information PS2B that is received from the second communication apparatus 2B, and the second location information PS2C that is received from the second communication apparatus 2C at the instruction unit 312 at a time point when the first communication apparatus 1 communicates with the fixed communication apparatus 4.

For example, the position corresponding to the second location information PS2A is a position of 12 m on the side opposite to the running direction of the competitor U with respect to the position mark PO as indicated by the position mark P12. In addition, the position corresponding to the second location information PS2B is a position of 23 m on the side opposite to the running direction of the competitor U with respect to the position mark PO as indicated by the position mark P23. In addition, the position corresponding to the second location information PS2C is a position of 27 m on the side opposite to the running direction of the competitor U with respect to the position mark PO as indicated by the position mark P27.

Hatching is provided on position mark P12, position mark P23, and position mark P27, which correspond to the second location information PS2A, the second location information PS2B, and the second location information PS2C, respectively.

In addition, as indicated in the data display diagram 500, the data used by the position calculation unit 313 to calculate the position of the second competitor U21 at the first date/time represented by the first date/time information TM1 is a time difference ΔTA and a running velocity VA. In addition, the data used by the position calculation unit 313 to calculate the position of the second competitor U22 at the first date/time represented by the first date/time information TM1 is a time difference ΔTB and a running velocity VB. In addition, the data used by the position calculation unit 313 to calculate the position of the second competitor U23 at the first date/time represented by the first date/time information TM1 is a time difference ΔTC and a running velocity VC.

The time difference ΔTA is a difference between the first date/time represented by the first date/time information TM1, and the second date/time represented by the second date/time information TM2 acquired by the second acquiring unit 211 of the second communication apparatus 2A in association with the second location information PS2A. For example, the time difference ΔTA is two seconds.

The time difference ΔTB is a difference between the first date/time represented by the first date/time information TM1, and the second date/time represented by the second date/time information TM2 acquired by the second acquiring unit 211 of the second communication apparatus 2B in association with the second location information PS2B. For example, the time difference ΔTB is four seconds.

The time difference ΔTC is a difference between the first date/time represented by the first date/time information TM1, and the second date/time represented by the second date/time information TM2 acquired by the second acquiring unit 211 of the second communication apparatus 2C in association with the second location information PS2C. For example, the time difference ΔTC is eight seconds.

Note that, the time difference ΔTA to the time difference ΔTC are less than 10 seconds. The reason for this is that the time difference ΔTA to the time difference ΔTC result from the fact that the time interval of transmission of the second location information PS2 to the server apparatus 3 from each of the second communication apparatus 2A to the second communication apparatus 2C is 10 seconds.

The running velocity VA is the running velocity of the second competitor U21 when the second location information PS2A is acquired by the second acquiring unit 211 of the second communication apparatus 2A. For example, the running velocity VA is 2.5 m/sec.

The running velocity VB is the running velocity of the second competitor U22 when the second location information PS2B is acquired by the second acquiring unit 211 of the second communication apparatus 2B. For example, the running velocity VB is 1.5 m/sec.

The running velocity VC is the running velocity of the second competitor U23 when the second location information PS2C is acquired by the second acquiring unit 211 of the second communication apparatus 2C. For example, the running velocity VC is 2.0 m/sec.

Note that, the running velocity VA to the running velocity VC are calculated by the same method as the method of calculating the first velocity V1 by the first complement unit 113 of the first communication apparatus 1.

Next, with reference to FIG. 7, the processes of the position calculation unit 313 and the determination unit 314 of the server apparatus 3 are further described.

A position display diagram 600 illustrated in FIG. 7 indicates, in addition to the content of the data display diagram 500 illustrated in FIG. 6, the positions of the second competitor U21, the second competitor U22 and the second competitor U23 at the first date/time represented by the first date/time information TM1 calculated by the position calculation unit 313.

The second competitor U21 has a time difference ΔTA of two seconds and a running velocity VA of 2.5 m/sec, and therefore moves forward 5 m (=2×2.5) during the time difference ΔTA. As a result, as indicated by the broken line arrow in FIG. 7, the second competitor U21 reaches the position of the position mark P7 from the position of the position mark P12 at the first date/time represented by the first date/time information TM1. Specifically, at the first date/time represented by the first date/time information TM1, the distance between the first competitor U1 and the second competitor U21 is 7 m.

The second competitor U22 has a time difference ΔTB of four seconds and a running velocity VB d f1.5 m/sec, and therefore moves forward 6 m (=4×1.5) during the time difference ΔTA. As a result, the second competitor U22 reaches the position of position mark P17 from the position of position mark P23 at the first date/time represented by the first date/time information TM1. Specifically, at the first date/time represented by the first date/time information TM1, the distance between the first competitor U1 and the second competitor U22 is 17 m.

The second competitor U23 has a time difference ΔTC of eight seconds and a running velocity VB of 2.0 m/sec, and therefore moves forward 16 m (=8×2.0) during the time difference ΔTA. As a result, the second competitor U23 reaches the position of the position mark P10 from the position of the position mark P27 at the first date/time represented by the first date/time information TM1. Specifically, at the first date/time represented by the first date/time information TM1, the distance between the first competitor U1 and the second competitor U23 is 10 m.

The position mark P7, the position mark P17, and the position mark P10, which are positions corresponding to the second location information PS2A, the second location information PS2B, and the second location information PS2C, respectively are colored with black.

As described above, the position calculation unit 313 calculates the positions of the second competitor U21, the second competitor U22 and the second competitor U23 at the first date/time represented by the first date/time information TM1. Then, at the first date/time represented by the first date/time information TM1, the determination unit 314 determines that the second competitor U21 is the second place, the second competitor U23 the third place, the second competitor U22 the fourth place.

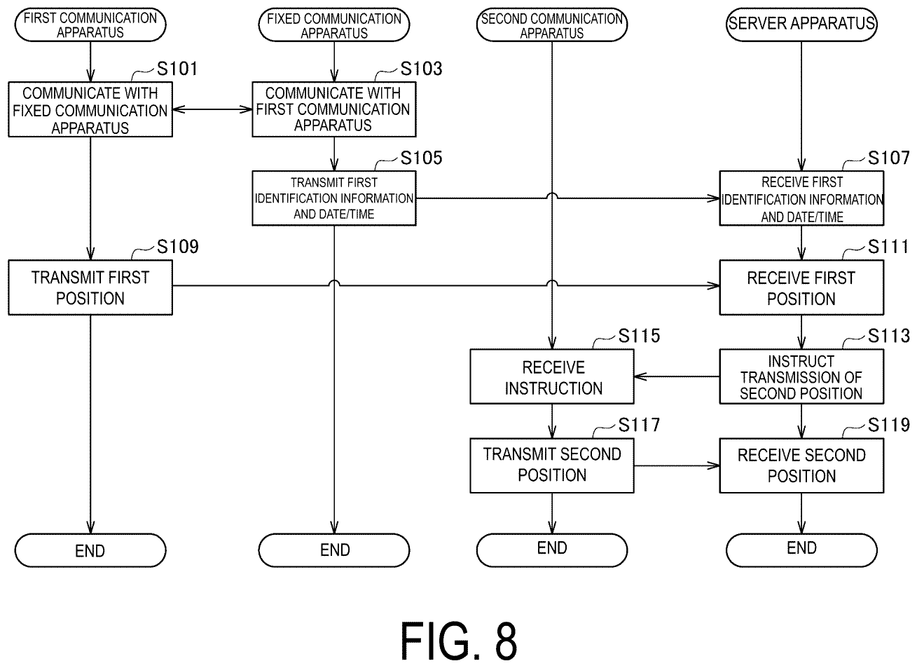

Next, with reference to FIG. 8, a process of the position management system 100 is described. FIG. 8 is a flowchart illustrating an example of a process of the position management system 100.

First, as illustrated in FIG. 5, at step S101, the first communication apparatus 1 attempts to communicate with the fixed communication apparatus 4 when the first competitor U1 enters the detection region DA.

Next, at step S103, the fixed communication apparatus 4 establishes the communication with the first communication apparatus 1. Then, the fixed communication apparatus 4 acquires the first identification information JD from the first communication apparatus 1. In addition, the fixed communication apparatus 4 acquires the fixed date/time information TMF from the GNSS system 5.

Next, at step S105, the fixed communication apparatus 4 transmits to the server apparatus 3 the first identification information JD1, the fixed location information PSF, and the fixed date/time information TMF.

Next, at step S107, the server apparatus 3 receives from the fixed communication apparatus 4 the first identification information JD1, the fixed location information PSF, and the fixed date/time information TMF.

Next, at step S109, the first communication apparatus 1 acquires from the GNSS system 5 the first location information PS1 and the first date/time information TM1, and transmits to the server apparatus 3 the acquired first location information PS1 and first date/time information TM1.

Next, at step S111, the server apparatus 3 receives from the first communication apparatus 1 the first location information PS1 and the first date/time information TM1.

Next, at step S113, the server apparatus 3 transmits the instruction information CM to the second communication apparatus 2. The instruction information CM is information that instructs transmission of the second location information PS2 and the second date/time information TM2 to the server apparatus 3.

Next, at step S115, the second communication apparatus 2 receives the instruction information CM.

Next, at step S117, the second communication apparatus 2 transmits the second location information PS2 and the second date/time information TM2 to the server apparatus 3.

Next, at step S119, the server apparatus 3 receives from the second communication apparatus 2 the second location information PS2 and the second date/time information TM2. Thereafter, the process is completed.

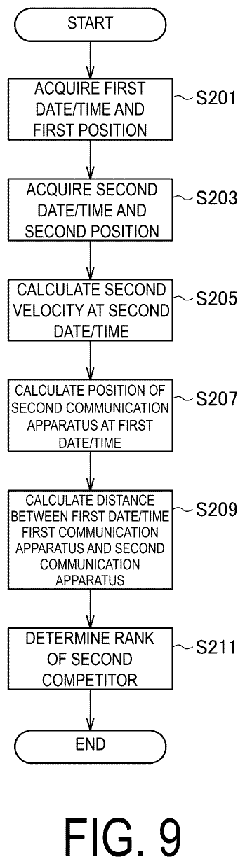

Next, with reference to FIG. 9, a process of the server apparatus 3 is described. FIG. 9 is a flowchart illustrating an example of a process of the server apparatus 3.

First, as illustrated in FIG. 9, at step S201, the reception unit 311 receives from the first communication apparatus 1 the first location information PS1, and the first date/time information TM1.

Next, at step S203, the reception unit 311 receives from the second communication apparatus 2 the second location information PS2 and the second date/time information TM2.

Next, at step S205, the position calculation unit 313 calculates the second velocity V2 that is the velocity of the movement of the second competitor U2.

Next, at step S207, the position calculation unit 313 calculates the position of the second communication apparatus 2 at the first date/time represented by the first date/time information TM1.

Next, at step S209, the determination unit 314 calculates the distance between the first communication apparatus 1 and the second communication apparatus 2 at the first date/time represented by the first date/time information TM1.

Next, at step S211, the determination unit 314 determines the rank RN of the second competitor U2. Thereafter, the process is completed.

### Embodiment and Operational Effect

As described above with reference to FIGS. 1 to 9, the position management system 100 according to the embodiment includes the first communication apparatus 1 attached to the first competitor U1 who participates in a marathon in which competitors moves along the course CU, the first communication apparatus 1 being configured to acquire the first location information PS1 representing a position of the first competitor U1 from the GNSS system 5, the second communication apparatus 2 attached to the second competitor U2 different from the first competitor U1 who participates in the marathon, the second communication apparatus 2 being configured to acquire the second location information PS2 representing a position of the second competitor U2 from the GNSS system 5, the server apparatus 3 configured to receive the first location information PS1 from the first communication apparatus 1, and receive the second location information PS2 from the second communication apparatus 2, and the fixed communication apparatus 4 disposed at a predetermined position in the course CU, and configured to communicate with the first communication apparatus 1 and the second communication apparatus 2. The first communication apparatus 1 transmits the first location information PS1 to the server apparatus 3 when the first communication apparatus 1 communicates with the fixed communication apparatus 4, and the server apparatus 3 causes the second communication apparatus 2 to transmit the second location information PS2 when the first communication apparatus 1 and the fixed communication apparatus 4 communicate with each other.

Specifically, the first communication apparatus 1 transmits the first location information PS1 to the server apparatus 3 when the first communication apparatus 1 communicates with the fixed communication apparatus 4, and the server apparatus 3 causes the second communication apparatus 2 to transmit the second location information PS2 when the first communication apparatus 1 and the fixed communication apparatus 4 communicate with each other.

In this manner, when the first communication apparatus 1 and the fixed communication apparatus 4 communicate with each other, the server apparatus 3 can acquire the first location information PS1 and the second location information PS2. Thus, the position of the first competitor U1 and the position of the second competitor U2 can be acquired.

In the position management system 100, the first communication apparatus 1 acquires the first date/time information TM1 representing a date/time corresponding to the first location information PS1 from the GNSS system 5, and transmits to the server apparatus 3 the first location information PS1 in association with the first date/time information TM1, and the second communication apparatus 2 acquires the second date/time information TM2 representing a date/time corresponding to the second location information PS2 from the GNSS system 5, and transmits to the server apparatus 3 the second location information PS2 in association with the second date/time information TM2.

In this manner, when the first communication apparatus 1 communicates with the fixed communication apparatus 4, the server apparatus 3 can acquire the first date/time information TM1, the first location information PS1, the second date/time information TM2, and the second location information PS2. Thus, the position of the first competitor U1 and the position of the second competitor U2 when the first communication apparatus 1 communicates with the fixed communication apparatus 4 can be correctly calculated.

In the position management system 100, the server apparatus 3 stores course information JC representing the course CU, and determines the rank RN of the first competitor U1 and the rank RN of the second competitor U2 in the marathon based on the course information JC, the first location information PS1, the first date/time information TM1, the second location information PS2, and the second date/time information TM2.

Thus, the rank RN of the first competitor U1 and the rank RN of the second competitor U2 in the marathon can be properly determined.

In the position management system 100, when the rank RN of the first competitor U1 is higher than the rank RN of the second competitor U2, and the first communication apparatus 1 communicates with the fixed communication apparatus 4, the server apparatus 3 causes the second communication apparatus 2 to transmit the second location information PS2.

In this case, even in the case where the rank RN of the first competitor U1 is not the first place, when the rank RN of the first competitor U1 is higher than the rank RN of the second competitor U2, and the first communication apparatus 1 communicates with the fixed communication apparatus 4, the position of the first competitor U1 and the position of the second competitor U2 can be acquired.

In the position management system 100, when the rank RN of the first competitor U1 is equal to or higher than a finishing rank in the marathon, and the rank RN of the first competitor U1 is higher than the rank RN of the second competitor U2, and, the first communication apparatus 1 communicates with the fixed communication apparatus 4, the server apparatus 3 causes the second communication apparatus 2 to transmit the second location information PS2.

In this case, even in the case where the rank RN of the first competitor U1 is not the first place, when the rank RN of the first competitor U1 is equal to or higher than the finishing rank in the marathon, and the rank RN of the first competitor U1 is higher than the rank RN of the second competitor U2, and, the first communication apparatus 1 communicates with the fixed communication apparatus 4, the position of the first competitor U1 and the position of the second competitor U2 can be acquired.

In the position management system 100, when the rank RN of the first competitor U1 is a first place, and the first communication apparatus 1 communicates with the fixed communication apparatus 4, the server apparatus 3 causes the second communication apparatus 2 to transmit the second location information PS2.

In this manner, when the rank RN of the first competitor U1 is the first place, and the first communication apparatus 1 communicates with the fixed communication apparatus 4, the position of the first competitor U1 and the position of the second competitor U2 can be acquired. Thus, the server apparatus 3 can provide the position of the competitor of most interest to the user watching the marathon.

In the position management system 100, when the first communication apparatus 1 communicates with the fixed communication apparatus 4, and the second communication apparatus 2 is not in communication with the fixed communication apparatus 4, and, a distance between the first communication apparatus 1 and the second communication apparatus 2 along the course CU is equal to or smaller than the first threshold value TH1 before the first communication apparatus 1 communicates with the fixed communication apparatus 4, the server apparatus 3 causes the second communication apparatus 2 to transmit the second location information PS2.

In this case, even in the case where the rank RN of the first competitor U1 is not the first place, when the first communication apparatus 1 communicates with the fixed communication apparatus 4, and the second communication apparatus 2 is not communicated with the fixed communication apparatus 4, and, the distance of the first communication apparatus 1 and the second communication apparatus 2 along the course CU is equal to or smaller than the first threshold value TH1 before the first communication apparatus 1 communicates with the fixed communication apparatus 4, the server apparatus 3 can acquire the position of the first competitor U1 and the position of the second competitor U2 when the first communication apparatus 1 communicates with the fixed communication apparatus 4. Thus, by properly setting the first threshold value TH1, the second communication apparatus 2 for which the position is to be acquired can be properly limited when the first communication apparatus 1 communicates with the fixed communication apparatus 4.

In the position management system 100, when the first communication apparatus 1 communicates with the fixed communication apparatus 4, and the second communication apparatus 2 is not in communication with the fixed communication apparatus 4, and, a difference between the rank RN of the first competitor U1 and the rank RN of the second competitor U2 is equal to or smaller than the second threshold value TH2 before the first communication apparatus 1 communicates with the fixed communication, the server apparatus 3 causes the second communication apparatus 2 to transmit the second location information PS2.

In this case, even in the case where the rank RN of the first competitor U1 is not the first place, when the first communication apparatus 1 communicates with the fixed communication apparatus 4, and the second communication apparatus 2 is not communicated with the fixed communication apparatus 4, and the difference between the rank RN of the first competitor U1 and the rank RN of the second competitor U2 before the first communication apparatus 1 communicates with the fixed communication apparatus is equal to or smaller than the second threshold value TH2, the server apparatus 3 can acquire the position of the second competitor U2 when the first communication apparatus 1 communicates with the fixed communication apparatus 4. Thus, by properly setting the second threshold value TH2, the second communication apparatus 2 for which the position is to be acquired can be properly limited when the first communication apparatus 1 communicates with the fixed communication apparatus 4.

In the position management system 100, when the first communication apparatus 1 communicates with the fixed communication apparatus 4, the first communication apparatus 1 calculates an elapsed time representing a period from a start of the marathon to the first date/time represented by the first date/time information TM1, and transmits the first location information PS1 and the first elapsed time information PD1 representing the elapsed time to the server apparatus 3.

Thus, the server apparatus 3 can acquire the first elapsed time information PD1. The first elapsed time information PD1 represents the period from the start of the marathon to the first date/time represented by the first date/time information TM1.

In the position management system 100, the server apparatus 3 causes the second communication apparatus 2 to transmit location information acquired before the first date/time as the second location information PS2.

As such, it suffices that when receiving the instruction information CM from the server apparatus 3, the second communication apparatus 2 transmits to the server apparatus 3 the latest second location information PS2 in the second location information PS2 stored in the second position storage unit 215 without communicating with the GNSS system 5. Thus, the processing of the second communication apparatus 2 can be simplified.

In the position management system 100, the second communication apparatus 2 calculates the velocity V2 of movement of the second competitor U2 based on the second location information PS2, and complements the second location information PS2 based on the velocity V2.

In this case, it is possible to increase the time interval of the acquisition of the second location information PS2 from the GNSS system 5 at the second communication apparatus 2. It should be noted that it is preferable to not use it for determination of the rank RN in the case where the course CU is curved because the position determined through complement may be different from the correct position.

In the position management system 100, when the first communication apparatus 1 and the fixed communication apparatus 4 communicate with each other, the server apparatus 3 causes the second communication apparatus 2 to transmit the second location information PS2 acquired before the first date/time, calculates the velocity V2 of movement of the second competitor U2 based on the second location information PS2 received, and calculates a position of the second communication apparatus 2 at the first date/time based on the second location information PS2 received and the velocity V2 of movement of the second competitor U2 calculated, and course information JC representing the course CU.

In this manner, the position of the second communication apparatus 2 at the first date/time can be properly calculated. Thus, the server apparatus 3 can properly calculate the distance between the first competitor U1 and the second competitor U2 when the first communication apparatus 1 and the fixed communication apparatus 4 communicate with each other. As a result, the server apparatus 3 can properly determine the rank RN of the second competitor U2 when the first communication apparatus 1 and the fixed communication apparatus 4 communicate with each other.

A position management method according to the embodiment is a method of a position management system 100, the position management system 100 including the first communication apparatus 1 attached to the first competitor U1 who participates in a marathon in which competitors moves along the course CU, the first communication apparatus 1 being configured to acquire the first location information PS1 representing a position of the first competitor U1 from the GNSS system 5, the second communication apparatus 2 attached to the second competitor U2 different from the first competitor U1 who participates in the marathon, the second communication apparatus 2 being configured to acquire the second location information PS2 representing a position of the second competitor U2 from the GNSS system 5, the server apparatus 3 configured to receive the first location information PS1 from the first communication apparatus 1, and receive the second location information PS2 from the second communication apparatus 2, and the fixed communication apparatus 4 disposed at a predetermined position in the course CU, and configured to communicate with the first communication apparatus 1 and the second communication apparatus 2, the method including transmitting, by the first communication apparatus 1, the first location information PS1 to the server apparatus 3 when the first communication apparatus 1 communicates with the fixed communication apparatus 4, and causing, by the server apparatus 3, the second communication apparatus 2 to transmit the second location information PS2 when the first communication apparatus 1 and the fixed communication apparatus 4 communicate with each other.

Thus, the position management method according to the embodiment can achieve an effect similar to that of the position management system 100 according to the embodiment.

### OTHER EMBODIMENTS

The present embodiment described above is a preferred embodiment. Note that the present embodiment described above is not given for the purpose of limitation, and various modification and implementation are possible without departing from the main points thereof.

The embodiment describes a case where the “competition” is a marathon, but the embodiment is not limited to this. The “competition” may be a triathlon, for example. In addition, the “competition” may be a half marathon, for example. The “competition” may be a cycle road race, for example.

The embodiment describes a case where the first competitor U1 is a competitor who runs at the front in a marathon, but the embodiment is not limited to this. It suffices that the first competitor U1 is equal to or higher than the finishing rank in the marathon. In addition, in the case where competitors form a plurality of groups in a marathon, the first competitor U1 may be a competitor who runs at the front in each group.

The embodiment describes a case where the “information processing apparatus” is the server apparatus 3, but the embodiment is not limited to this. It suffices that the “information processing apparatus” is an apparatus having a communication function and an information processing function. The “information processing apparatus” may be a personal computer, for example. In addition, the “information processing apparatus” may be a tablet apparatus or a smartphone, for example.

The embodiment describes a case where the second competitor U2 includes the second competitor U21, the second competitor U22, and the second competitor U23, but the embodiment is not limited to this. The second competitor U2 may include four or more competitors U.

The embodiment describes a case where the first communication apparatus 1 acquires the first location information PS1 from the GNSS system 5 at an interval of a predetermined time (for example, 10 seconds), and the second communication apparatus 2 acquires the second location information PS2 from the GNSS system 5 at an interval of a predetermined time (for example, 10 seconds), but the embodiment is not limited to this. The predetermined time may be one second, for example. In addition, the predetermined time may be two seconds to nine seconds, for example. In addition, the predetermined time may be 11 seconds or longer, for example.

The longer the predetermined time, the more power consumption of the battery 15 and the battery 25 can be reduced. The shorter the predetermined time, the more specific location information can be transmitted to the server apparatus 3 by the first communication apparatus 1 and the second communication apparatus 2.

The embodiment describes a case where the first transmission unit 112 of the first communication apparatus 1 transmits to the server apparatus 3 10 pieces of the first location information PS1 stored in the first position storage unit 115 of the first communication apparatus 1, and 10 pieces of the first date/time information TM1 stored in the first position storage unit 115 in association with the respective 10 pieces of the first location information PS1 every 100 seconds, for example, but the embodiment is not limited to this. For example, the first transmission unit 112 may be configured to transmit to the server apparatus 3 the latest first location information PS1 stored in the first position storage unit 115, and the first date/time information TM1 stored in the first position storage unit 115 in association with the latest first location information PS1 at an interval of a predetermined time.

The embodiment describes a case where the second transmission unit 212 of the second communication apparatus 2 transmits to the server apparatus 3 10 pieces of the second location information PS2 stored in the second position storage unit 215 of the second communication apparatus 2, and 10 pieces of the second date/time information TM2 stored in the second position storage unit 215 in association with the respective 10 pieces of the second location information PS2 every 100 seconds, for example, but the embodiment is not limited to this. For example, the second transmission unit 212 may be configured to transmit to the server apparatus 3 the latest second location information PS2 stored in the second position storage unit 215, and the second date/time information TM2 stored in the second position storage unit 215 in association with the latest second location information PS2 at an interval of a predetermined time.

In addition, the functional parts illustrated in FIGS. 2 to 5 illustrate functional configurations, and the specific implementation form is not restricted. That is, it is not necessary to mount hardware individually corresponding to each functional part, and it is possible to adopt a configuration in which one processor executes a program to implement the functions of a plurality of functional parts. In addition, a part of the function that is implemented by software in the above-mentioned embodiment may be implemented by hardware, or a part of the function that is implemented by hardware may be implemented by software. Furthermore, specific configurations of the first communication apparatus 1, the second communication apparatus 2, the server apparatus 3, and each unit of the fixed communication apparatus 4 may also be changed as desired without deviating from the gist.

In addition, the processing units in the flowchart illustrated in FIG. 8 are divided in accordance with the details of the main process for the sake of easy understanding of the processes of the position management system 100. The division and names of the processing units in the flowchart illustrated in FIG. 8 are not limitative, and the processing may be divided into more processing units, or a single processing unit may be divided to include more processes in accordance with the details of the processing. In addition, the above-mentioned processing order of the flowchart is not limited to the illustrated example.

In addition, the processing units in the flowchart illustrated in FIG. 9 are divided in accordance with the details of the main process for the sake of easy understanding of the processes of the server apparatus 3. The division and names of the processing units in the flowchart illustrated in FIG. 9 are not limitative, and the processing may be divided into more processing units, or a single processing unit may be divided to include more processes in accordance with the details of the processing. In addition, the above-mentioned processing order of the flowchart is not limited to the illustrated example.

In addition, the position management method of the position management system 100 may be implemented by causing processors provided in the first communication apparatus 1, the second communication apparatus 2, the server apparatus 3, and the fixed communication apparatus 4 to execute the control program PG corresponding to the position management method of the position management system 100. The processor corresponds to the first processor 11A to the fourth processor 41A. The control program PG corresponds to the first control program PG1 to the fourth control program PG4.

In addition, the control program PG may be recorded in a computer-readable recording medium.

As the recording medium, magnetic and optical recording mediums or semiconductor memory devices may be used. Specifically, examples of the recording medium include a flexible disk, an HDD, a CD-ROM (compact disk read only memory), a DVD, a Blu-ray (registered trademark) disc, a magneto-optical disk, a flash memory, and a mobile-type or fixed-type recording medium such as a card-type recording medium. In addition, the recording medium may be a nonvolatile storage apparatus such as a RAM, a ROM, and an HDD that is an internal storage apparatus provided in each of the first communication apparatus 1, the second communication apparatus 2, the server apparatus 3, and the fixed communication apparatus 4.

The position management method of the position management system 100 may be implemented by storing the control program PG in a server apparatus and the like, and downloading the control program PG from the server apparatus to each of the first communication apparatus 1, the second communication apparatus 2, and the fixed communication apparatus 4.

What is claimed is:

1. A position management system comprising:
a first communication apparatus attached to a first competitor who participates in a competition in which competitors moves along a course, the first communication apparatus being configured to acquire first location information representing a position of the first competitor from a GNSS system;
a second communication apparatus attached to a second competitor different from the first competitor who participates in the competition, the second communication apparatus being configured to acquire second location information representing a position of the second competitor from the GNSS system;
an information processing apparatus configured to receive the first location information from the first communication apparatus, and receive the second location information from the second communication apparatus; and
a fixed communication apparatus disposed at a predetermined position in the course, and configured to communicate with the first communication apparatus and the second communication apparatus, wherein
the first communication apparatus transmits the first location information to the information processing apparatus when the first communication apparatus communicates with the fixed communication apparatus, and
the information processing apparatus causes the second communication apparatus to transmit the second location information when the first communication apparatus and the fixed communication apparatus communicate with each other.

2. The position management system according to claim 1, wherein
the first communication apparatus acquires first date/time information representing a date/time corresponding to the first location information from the GNSS system, and transmits to the information processing apparatus the first location information in association with the first date/time information, and
the second communication apparatus acquires second date/time information representing a date/time corresponding to the second location information from the GNSS system, and transmits to the information processing apparatus the second location information in association with the second date/time information.

3. The position management system according to claim 2, wherein the information processing apparatus
stores course information representing the course, and
determines a rank of the first competitor and a rank of the second competitor in the competition based on the course information, the first location information, the first date/time information, the second location information, and the second date/time information.

4. The position management system according to claim 3, wherein when the rank of the first competitor is higher than the rank of the second competitor, and the first communication apparatus communicates with the fixed communication apparatus, the information processing apparatus causes the second communication apparatus to transmit the second location information.

5. The position management system according to claim 4, wherein when the rank of the first competitor is equal to or higher than a finishing rank in the competition, and the rank of the first competitor is higher than the rank of the second competitor, and, the first communication apparatus communicates with the fixed communication apparatus, the information processing apparatus causes the second communication apparatus to transmit the second location information.

6. The position management system according to claim 3, wherein when the rank of the first competitor is a first place, and the first communication apparatus communicates with the fixed communication apparatus, the information processing apparatus causes the second communication apparatus to transmit the second location information.

7. The position management system according to claim 1, wherein when the first communication apparatus communicates with the fixed communication apparatus, and the second communication apparatus is not in communication with the fixed communication apparatus, and, a distance between the first communication apparatus and the second communication apparatus along the course is equal to or smaller than a first threshold value before the first communication apparatus communicates with the fixed communication apparatus, the information processing apparatus causes the second communication apparatus to transmit the second location information.

8. The position management system according to claim 3, wherein when the first communication apparatus communicates with the fixed communication apparatus, and the second communication apparatus is not in communication with the fixed communication apparatus, and, a difference between the rank of the first competitor and the rank of the second competitor is equal to or smaller than a second threshold value before the first communication apparatus communicates with the fixed communication, the information processing apparatus causes the second communication apparatus to transmit the second location information.

9. The position management system according to claim 2, wherein when the first communication apparatus communicates with the fixed communication apparatus, the first communication apparatus calculates an elapsed time representing a period from a start of the competition to the first date/time represented by the first date/time information, and transmits the first location information and elapsed time information representing the elapsed time to the information processing apparatus.

10. The position management system according to claim 9, wherein the information processing apparatus causes the second communication apparatus to transmit location information acquired before the first date/time as the second location information.

11. The position management system according to claim 10, wherein
the second communication apparatus
calculates a velocity of movement of the second competitor based on the second location information, and
complements the second location information based on the velocity.

12. The position management system according to claim 10, wherein when the first communication apparatus and the fixed communication apparatus communicate with each other, the information processing apparatus
causes the second communication apparatus to transmit the second location information acquired before the first date/time,
calculates a velocity of movement of the second competitor based on the second location information received, and
calculates a position of the second communication apparatus at the first date/time based on the second location information received and the velocity of movement of the second competitor calculated, and course information representing the course.

13. A position management method of a position management system, the position management system including:
a first communication apparatus attached to a first competitor who participates in a competition in which competitors moves along a course, the first communication apparatus being configured to acquire first location information representing a position of the first competitor from a GNSS system;
a second communication apparatus attached to a second competitor different from the first competitor who participates in the competition, the second communication apparatus being configured to acquire second location information representing a position of the second competitor from the GNSS system;
an information processing apparatus configured to receive the first location information from the first communication apparatus, and receive the second location information from the second communication apparatus; and
a fixed communication apparatus disposed at a predetermined position in the course, and configured to communicate with the first communication apparatus and the second communication apparatus,
the method comprising:
transmitting, by the first communication apparatus, the first location information to the information processing apparatus when the first communication apparatus communicates with the fixed communication apparatus, and
causing, by the information processing apparatus, the second communication apparatus to transmit the second location information when the first communication apparatus and the fixed communication apparatus communicate with each other.
